(19) United States
(12) Patent Application Publication
(10) Pub. No.: US 2004/0122631 A1
(43) Pub. Date: Jun. 24, 2004

(54) Method and apparatus for simulating the light distribution in a focal point

(76) Inventor: Johannes Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/324,813

(22) Filed: Dec. 20, 2002

(51) Int. Cl. G06F 17/10

(52) U.S. Cl. 703/2

(57) ABSTRACT

A method is disclosed for calculating an optical disk readout signal that represents a light power distribution, whilst executing the following simulated steps:

passing a beam of coherent light with wavelength λ through an entrance objective's pupil and focusing the beam on the disk for interaction

after interaction with the disk, collecting the light through an optical collector lens for passage through an exit pupil operating as a detection plane

and executing to calculate a light power distribution on the detection plane for a range of potential disk positions R(u,v), and such including to calculate the following:

$$\begin{matrix}F ( {u}_{k} , {v}_{l} ) = 2 R / N {\sum }_{m = 0}^{N - 1} A ( {x}_{m} , {v}_{l} ) exp [ - 2 i {u}_{k} {x}_{m} ] , & k = 0 … M - 1 , with \\ A ( {x}_{m} , {v}_{l} ) = 2 R / N {\sum }_{n = 0}^{N - 1} f ( {x}_{m} , {y}_{n} ) exp [ - 2 i {v}_{l} , {y}_{n} ] , & l = 0 … M - 1.\end{matrix}$$

In particular, the method includes to use a chirp z-transform (CZT) which transforms a vector ƒ of length N to a vector A of length M according to

$${A}_{k} = {[ CZT ( f ) ]}_{k} = {\sum }_{n = 0}^{N - 1} {{f}_{n} ( {aw}^{- k} )}^{- n} , k = 0 … M - 1 ,$$

where a and w are user-defined complex constants to define a spiral path z=aw^{-k} in the z-plane.

### BACKGROUND OF THE INVENTION

The invention relates to a method for calculating an optical disk readout signal that represents a light power distribution, whilst executing a sequence of simulation steps that involve inter alia the calculating of a Fast Fourier Transform (FFT), as has furthermore been recited in the preamble of claim 1. In particular, the calculation should be done for a plurality of disk positions respectively represented by values of R(u,v), which effectively is the disk's reflection function. The eventual detector signal S derives from placing one or more detectors in the detection plane. Inasmuch as the number of positions can be large, and the sampling grid may be chosen to have in the order of 1 M positions, the calculation of the Fast Fourier Transforms may necessitate an appreciable computational effort.

Computing the readout signal of an optical disk involves Fourier Transforms from the objective lens pupil to the disk and, after interaction with the disk, from the disk back to the objective pupil. Traditionally, the complex two-dimensional Fourier Transform has been evaluated numerically as a two-dimensional FFT. In order to obtain a sufficient resolution in the planes involved, the chosen sampling grids are typically 1024×1024 or larger, which results in a substantial computation time if the calculations are repeated many times.

Generally, the mathematical modelling of the readout process of optical disks has been explored ever since the technology emerged. Various simulation models are used to compute the various signals, to predict the interaction between disk and optical pickup, and to optimise disk formats, player optics, and channel electronics. Commercial software has been available that is tailored to the specific disk geometry and the optical components used in optical recording. The commonly used physical model is based on a scalar description of the. readout process, involving Fourier Transforms from the scanning objective pupil to the disk, and from the disk back to the objective pupil. In order to obtain accurate results, the three planes involved must be sampled with a sufficient resolution. In practice, this implies the use of sample grids of 1024×1024 points or more. Although single-point calculations to find the light distribution of the light diffracted from the disk for a particular configuration are quite feasible, it is relatively impractical to simulate entire scans of the spot along some desired path on the disk. Often, analysis requires one or more scans to find the proper relation between parameters, or the sensitivity of a figure-of-merit with respect to system tolerances. Examples are the estimating of so-called “jitter windows” of the readout signal, and the amplitude and offset sensitivity of servo signals derived from the light returned.

A simulated scan consists of a single procedure to define and simulate the disk and spot geometries, followed by a repeated procedure to find the light power distribution diffracted from the disk into the objective lens pupil. During this repeated part, one or more parameters are stepped through some predefined range that corresponds to the analysis required.

Specifically, the computations of the repeated part determine the overall simulation time. Using the scalar model involves a multiplication of the spot amplitude with the complex disk reflection function, a Fourier Transform from the disk to the objective lens, which for distinguishing between the forward and the returning paths will be called the collector lens, additional computations to find the light power distribution in the pupil, and finally deriving the desired eventual signals.

The present inventor has recognised an advantageous solution that can be attained by using a discrete transform that transforms a vector ƒ of length N to a vector A of length M whilst defining a path in the z-plane, for so effecting a speed-up of the calculation by an appreciable factor. In fact, the discretised Fourier Transform represents two steps, from ƒₘₙ→Aₘₗ→Fₖₗ. Now, the using of a chirp z-transform allows to transform a vector ƒ of length N to a vector A of length M, along a spiral path z=aw^{-k} in the z-plane. In particular, the transform in question allows to choose appropriate values for a and w, and to thereby effectively zoom-in on a part of the spectrum with a user-defined resolution. Through appropriate selection of the parameter values, the number of calculations may be reduced by an agreeable factor.

### SUMMARY TO THE INVENTION

In consequence, amongst other things, it is an object of the present invention to use the above-mentioned transform to speed-up the processing and thereby to allow undertaking of introducing a wider range of instrumental parameters.

Now therefore, according to one of its aspects the invention is characterised according to the characterising part of claim 1.

The invention also relates to an apparatus arranged for implementing a method as claimed in claim 1, and to a computer program and to a computer program product comprising instructions for controlling a computer for implementing such method. Further advantageous aspects of the invention are recited in dependent Claims.

### BRIEF DESCRIPTION OF THE DRAWING

These and further aspects and advantages of the invention will be discussed more in detail hereinafter with reference to the disclosure of preferred embodiments, and in particular with reference to the appended Figures that show:

FIG. 1, a readout geometry for an optical disk;

FIG. 2, sampling grids in the objective/collector and disk planes, respectively, for the state of the art;

FIG. 3, various matrices developing during implementing the state of the art method;

FIG. 4, sampling grids developing for the method according to the present invention;

FIG. 5, effects of applying a window on the spot and on the transformed spot;

FIG. 6, disk geometries used for comparing the two methods;

FIG. 7, data signals produced by the state of the art for cases A and B;

FIG. 8a, results for the state of the art and the inventive method for case A;

FIG. 8b, results for the state of the art and the inventive method for case B.

### DETAILED DESCRIPTION OF PREFERRED EMBODIMENTS

Computation of the readout signal of an optical disk involves Fourier transforms from the objective lens pupil to the disk and, after interaction with the disk, from the disk to the objective pupil. Traditionally the complex two-dimensional Fourier transform is numerically evaluated as a two-dimensional FFT. In order to obtain sufficient resolution in the involved planes, the sampling grid sizes must be chosen typically 1024×1024 or higher, which results in a substantial computation time if the calculation is repeated many times.

Mathematical modeling of the readout process of optical disks has been explored ever since the technology emerged. Various simulation models are used to compute signals, to predict the interaction between disk and optical pickup, and to optimize disk formats, player optics and channel electronics. Commercial software is available which is tailored to the specific disk geometry and optical components used in optical recording. The commonly used physical model is based on a scalar description of the readout process, involving Fourier transforms from the scanning objective pupil to the disk, and from the disk back to the objective pupil. In order to obtain accurate results, the three planes involved in these transforms must be sampled with sufficient resolution. In practice this implies the use of sampling grids of 1024×1024 points or more. Although single point, calculations to find the light distribution of the light diffracted from the disk for a particular configuration, are quite feasible, it is quite impractical to simulate entire scans of the spot along some desired path on the disk. Often analysis requires one or more scans to find the proper relation between parameters, or the sensitivity of a figure-of-merit with respect to system tolerances. Examples are to estimate the so-called “jitter windows” of the readout signal, and the amplitude and offset sensitivity of servo signals derived from the returning light.

A simulated scan consists of a single procedure to define and simulate the disk- and spot geometry, followed by a repeated procedure to find the light power distribution diffracted from the disk into the objective lens pupil. During this repeated part one or more parameters are stepped through some predefined range, corresponding to the required analysis.

Specifically the computations of the repeated part determine the overall simulation time. Using the scalar model involve a multiplication of the spot amplitude with the (complex) disk reflection function, a Fourier transform from the disk to the objective lens (to distinguish between the forward- and returning path we will refer to this lens as the collector lens) additional computations to find the light power distribution in the pupil, and finally deriving the desired signals.

General Procedure for Computing Optical Disk Readout

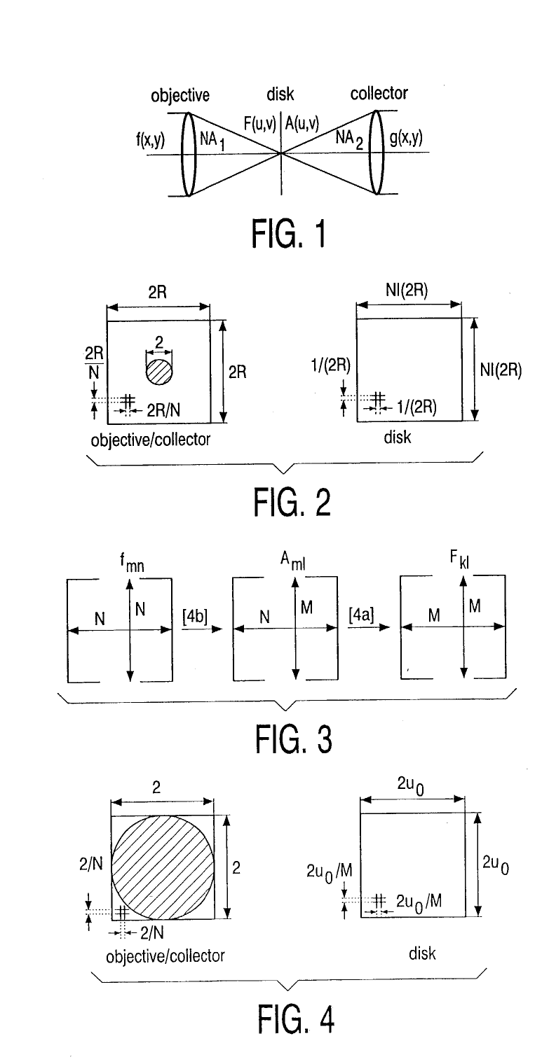

The basic arrangement for reading out optical disks is shown in FIG. 1. An objective lens with a numerical aperture NA₁ focuses a beam of coherent light with wavelength λ onto the disk. In the plane of the objective's entrance pupil an illumination distribution ƒ(x,y) is present, resulting in a spot amplitude F(u,v) in the plane of the disk. Interaction with the disk involves a multiplication of F(u,v) with a reflection function R(u,v) such that A(u,v)=F(u,v)×R(u,v), and a collector lens with numerical aperture NA₂ collects the light. This results in a light distribution g(x,y) in the exit pupil of the lens. The exit pupil is considered as the detection plane of the system, for which the power distribution must be computed. The distributions ƒ, F, A and g are all complex scalar fields, conforming to the scalar propagation model which is used.

The goal of the computation is to determine the light power distribution in the detection plane for a potential large number of disk positions, i.e. many values of R(u,v). We will refer to such a sequence of positions as a scan, which results in a signal S obtained from placing one or more detectors in the detection plane. In general S is a combination of power distributions integrated over suitable detector areas, for example the data signal itself is obtained by integration of the power density over the entire exit pupil region (Central Aperture detection). The procedure for computing the output signal for a scan of Nₛ points is as follows:

Define ƒ(x,y)

F(u,v)=Fourier[ƒ(x,y)];j=0

Compute Rⱼ(u,v) for position j

A(u,v)=F(u,v)×R(u,v)

g(x,y)=Fourier[A(u,v)]

I(x,y)=|g(x,y)|²

Compute Sⱼ from I(x,y)

If j<Nₛ→j=j+1; goto 3

end

Here Fourier[ ] denotes the two-dimensional Fourier transform. In the procedure the steps (3)-(7) dominate the overall computation time, as they must be evaluated for each scan position. Next we discuss the computation of the Fourier transforms.

Objective to Disk

The amplitude on the disk F(u,v) resulting from an illumination ƒ(x,y) in the objective's entrance pupil plane follows from a two-dimensional Fourier transform:

$$F ( u , v ) = {\int }_{- ∞}^{+ ∞} {\int }_{- ∞}^{+ ∞} f ( x , y ) exp [ - 2 π i ( ux - vy ) ] ⅆ x ⅆ y . \qquad ( 1 )$$

where (x,y) are the coordinates in the objective's pupil plane normalized on the pupil radius, and (u,v) the coordinates in the disk plane expressed in ‘diffraction units’ λ/NA. For numerical computation we discretize (1) as follows:

$$\begin{matrix}{x}_{m} = ( - 1 + \frac{2 m + 1}{N} ) R & m = 0 … N - 1 \\ {y}_{n} = ( - 1 + \frac{2 n + 1}{N} ) R & n = 0 … N - 1 \\ {u}_{k} = ( - 1 + \frac{2 k + 1}{M} ) {u}_{0} & k = 0 … M - 1 \\ {v}_{l} = ( - 1 + \frac{2 l + 1}{M} ) {u}_{0} & l = 0 … M - 1.\end{matrix} \qquad ( 2 )$$

The dimensionless and normalized parameters R and u₀ define the regions for which the computation is carried out in the pupil- and disk planes, respectively. We set dx=dy=2R/N and u₀=ũ₀/(λ/NA), where 2ũ₀ is the real-space length of the computation area on the disk. Then we have

$$\begin{matrix}F ( {u}_{k} , {v}_{l} ) = \frac{4 {R}^{2}}{{N}^{2}} {\sum }_{m = 0}^{N - 1} {\sum }_{n = 0}^{N - 1} f ( {x}_{m} , {y}_{n} ) exp [ - 2 π i ( {u}_{k} {x}_{m} + {v}_{l} {y}_{n} ) ] ⇒ & & ( 3 ) \\ F ( {u}_{k} , {v}_{l} ) = \frac{2 R}{N} {\sum }_{m = 0}^{N - 1} A ( {x}_{m} , {v}_{l} ) exp [ - 2 π i {u}_{k} {x}_{m} ] & k = 0 … M - 1 , & ( 4 a ) \\ with A ( {x}_{m} , {v}_{l} ) = \frac{2 R}{N} {\sum }_{n = 0}^{N - 1} f ( {x}_{m} , {y}_{n} ) exp [ - 2 πi {v}_{l} {y}_{n} ] & l = 0 … M - 1. & ( 4 b )\end{matrix}$$

The expressions (4a) and (4b) do not (yet) represent a Discrete Fourier Transform (DFT), as no restrictions are imposed on the output area parameters M and u₀.

Disk to Collector

For the transform from the disk to the collector lens we can use the expressions (4a) and (4b) after replacing the appropriate variables, and replacing the input mesh size 2R/N with 2u₀/M. Without loss of generality we will assume that the NA's of the objective- and collector lenses are the same, i.e. that NA₁=NA₂=NA. We will discuss two methods for the numerical evaluation of (4a) and (4b).

Method I: Using a Two-Dimensional FFT

The DFT of a complex sequence ƒₙ is defined by

$$\begin{matrix}{{A}_{k} ≡ DFT ( f ) ]}_{k} = {\sum }_{n = 0}^{N - 1} {f}_{n} {w}^{nk} , & k = 0 … M - 1 ,\end{matrix} \qquad ( 5 )$$

where

w=exp[−2πi/N] (6)

This can be interpreted as the evaluation of the z-transform off along the unit circle in the z-plane. Since a DFT can be efficiently computed by the FFT algorithm, we write the discretized transform of (4a) and (4b) in the form of (5) and (6).

Objective to Disk

The exponential in (4b) is expanded as

$$\begin{matrix}exp [ - 2 π i {v}_{l} {y}_{n} ] = exp [ - 2 π i ( 1 - 1 / N - 1 / M + 1 / MN ) {u}_{0} R ] \times \\ exp [ - 2 π i ( 1 / N - 1 ) \frac{2 {u}_{0} R}{M} l ] \times \\ exp [ - 2 π i ( 1 / M - 1 ) \frac{2 {u}_{0} R}{N} n ] \times \\ exp [ - 2 π i \frac{4 {u}_{0} R}{MN} l n ] .\end{matrix} \qquad ( 7 )$$

For (4a) a similar expression applies. The FFT algorithm can compute (4a) and (4b) by setting

$$M = N , \\ \frac{4 {u}_{0} R}{N} = 1. \qquad ( 8 )$$

The first right-hand side exponential in (7) represents a fixed phase factor, which can be discarded for all practical purposes. The second exponential depends on l, and can be brought before the summation in (4b). This corresponds with a multiplication of the sum with a vector b:

b=cos(φ_{b})−i·sin(φ_{b}) with φ_{b}=π(1/N−1)l, l=0 . . . N−1 (9)

The third exponential depends on n, and can be combined with ƒ to form a new operand of the FFT. After applying (8) this constitutes a multiplication of ƒ with b.

When ƒ, A and F are represented by matrices of size N×N, computing (4b) corresponds to multiplying each of the rows of ƒ with b, then performing a FFT on each of the resulting rows, and finally multiplying the resulting rows again with b. The computation of (4a) is done in a similar way on the columns of A. To summarize, the Fourier transform algorithm according Method I comprises the following steps:

Multiply all rows of ƒ with b

Apply an FFT to the resulting rows

Multiply all resulting rows with b

Multiply all resulting columns with b

Apply an FFT to the resulting columns

Multiply all resulting columns with b

Multiply the resulting matrix with (2R/N)² to get F

Here ‘multiplication’ refers to term-by-term complex multiplication. After interchanging the order of the steps the procedure can be simplified to:

Multiply ƒ with B

Apply a 2D-FFT to the result

Multiply the result with B

Multiply the resulting matrix with (2R/N)² to get F

Here, B is a square matrix obtained from tern-by-term multiplication of B₁ with B₂, where B₁ is a matrix formed by the N-fold replication of b as rows, and B₂ by the N-fold replication of b as columns. Apart from the term-by-term matrix multiplications this algorithm requires one N×N-point 2D-FFT.

Disk to Collector

For method I we have 4u₀R/N=1 and M=N, so that the input mesh size becomes 2u₀/M=1/(2R). We now obtain the following procedure for the transform from A to g:

Multiply A with B

Apply a 2D-FFT to the result

Multiply the result with B

Multiply the resulting matrix with 1/(2R)² to get g

If only the power distribution in the collector lens is relevant, step (3) can be omitted. And since step (1) can be incorporated in the spot calculation, which has to be done just once for a scan, only steps (2) and (4) remain.

Resolution Considerations for Method I

The Fourier transform of (1) applies to normalized coordinates (x,y) and (u,v). In the objective- and collector planes (x,y) are normalized on the pupil radius, in the disk plane (u,v) are normalized on ‘diffraction units’ λ/NA. When the square sampling area in the objective/collector plane has a normalized size \overline{L}_{obj}, the normalized size of the sampling area on the disk \overline{L}_{disk} equals \overline{L}_{disk}=N/\overline{L}_{obj}. The real-space size L_{disk} is given by

$${L}_{disk} = \frac{N}{{\overline{L}}_{obj}} \frac{λ}{NA} = \frac{N}{2 R} \frac{λ}{NA} , \qquad ( 10 )$$

where we use the ‘underfill factor’ R>1 which defines the ratio of the sizes of the sampling area and the pupil. The resolution in the disk plane RES_{disk} equals

$${RES}_{disk} ≡ \frac{{L}_{disk}}{N} = \frac{1}{2 R} \frac{λ}{NA} . \qquad ( 11 )$$

FIG. 2 shows the sampling grids of the objective/collector- and disk planes for Method I. The dimensions are expressed in normalized units. Eq. (11) gives the important result that for a given λ and NA the resolution in the disk plane only depends on R, and not on N. Increasing N does not increase the resolution in the disk plane: only the size of the area for which samples are computed increases. The only way to increase RES_{disk} is to increase R, i.e. fill a larger part of the input matrix with zeros. The consequence thereof is that the resolution in the pupil decreases, which can only be compensated for by increasing N. Often this leads to a large N—as far as computing time and memory requirements are concerned—with a large part of the input matrix filled with seemingly pointless zeros.

### EXAMPLE

As an example we take the readout of a DVD disk. Suppose we want the collector's exit pupil to be sampled on a 80×80 grid, with a resolution in the disk plane of 50 nm or better. This is a practical choice, as the width's of the rings of the spot are about 600 nm, while the size of the pits, for which e.g. diffraction phenomena must be analyzed, is typically 500×300 nm. For DVD λ=650 nm, NA=0.6, while the pits have a channelbit length of 133 nm. At e.g. 3 samples/channelbit we need RES_{disk}=44.3 nm, so we find R=12.2. As we also require a 80×80 pupil resolution, we get N=976. In practice we choose N to be a power of 2, so here N=1024, resulting in a 84×84 pupil grid. Hence the transform requires a 1024×1024-point FFT. An implementation in the application package Matlab running on a 1.7 GHz Pentium-4 PC takes about 0.8 sec to perform this transform.

Method II: Using the Chirp Z-Transform

Objective to Disk

Again we start from the discretized version of the Fourier transform (4a) and (4b). This constitutes two steps, a first one from ƒ(xₘ,yₙ) to A(xₘ,vₗ) and a second one from A(xₘ,vₗ) to F(uₖ,vₗ), or, in matrix notation ƒₘₙ→Aₘₗ→Fₖₗ.

In order to compute (4a) and (4b) we use the chirp z-transform (CZT) which transforms a vector ƒ of length N to a vector A of length M:

$$\begin{matrix}{{A}_{k} ≡ CZT ( f ) ]}_{k} = {\sum }_{n = 0}^{N - 1} {{f}_{n} ( {aw}^{- k} )}^{- n} , & k = 0 … M - 1 ,\end{matrix} \qquad ( 12 )$$

Here, a and w are user-defined complex constants which define a spiral path z=aw^{-k} in the z-plane. The constant a=a₀ exp(2πiθ) defines the starting point of the spiral path.

The ratio of two successive points w=w₀ exp(2πiΔφ), has Δφ as the angular increment. The chirp z-transform off is the z-transform off evaluated along this spiral path, corresponding to a signal with a varying frequency and amplitude (a ‘chirp’). When w₀=1 the spiral path becomes a circular path, and the Aₖ become identical to the first M output samples of the N₀-point DFT of ƒₙ′=a⁻ⁿƒₙ, n=0 . . . N−1, padded with (N₀−N) zeros, where N₀=1/Δφ. If we restrict to the case w₀=1, we will refer to this DFT and it's input as being associated with a CZT.

The chirp z-transform can be efficiently computed by applying two (N+M−1)-point FFT's (a third one can be precomputed). By rewriting (4a) and (4b) in the form of (12) and choosing appropriate values for a and w, one can effectively ‘zoom-in’ on a part of the spectrum with a user-defined resolution. This is what we will do for the objective-to-disk and disk-to-collector transforms.

For the embodiment we apply no underfill, i.e. R≡1. For the first step from ƒ(xₘ,yₙ) to A(xₘ,vₗ) we have

$$\begin{matrix}exp [ - 2 {iv}_{l} {y}_{n} ] = exp [ - 2 i ( 1 - 1 \text{/} N - 1 \text{/} M + 1 \text{/} MN ) {u}_{0} ] \times \\ exp [ - 2 i ( 1 \text{/} N - 1 ) \frac{2 {u}_{0}}{M} l ] \times \\ exp [ - 2 i ( 1 \text{/} M - 1 ) \frac{2 {u}_{0}}{N} n ] \times \\ exp [ - 2 i \frac{4 {u}_{0}}{MN} ln ] .\end{matrix} \qquad ( 13 )$$

The first right-hand side exponential in (13) represents a fixed phase factor, which can be discarded for all practical purposes. The second exponential depends only on l, and can be brought before the summation in (4b). This corresponds with a multiplication of the sum with a vector c.

c=cos(φ_{c})−i·sin(φ_{c}), with

$$\begin{matrix}{φ}_{c} = 2 ( 1 \text{/} N - 1 ) \frac{2 {u}_{0}}{M} l , & l = 0 … M - 1.\end{matrix} \qquad ( 14 )$$

The third exponential depends on n, and hence defines the constant a in (12):

$$a = exp [ 2 i ( 1 \text{/} M - 1 ) \frac{2 {u}_{0}}{N} ] . \qquad ( 15 )$$

Finally the fourth exponential depends on ln, and hence defines the constant w in (12):

$$w = exp [ - 2 i \frac{4 {u}_{0}}{MN} ] . \qquad ( 16 )$$

For the full transform from ƒ to F we must apply the following steps:

Apply a CZT to all N rows of ƒ

Multiply the resulting N rows with c

Apply a CZT to all resulting M columns

Multiply all resulting M columns with c,

Multiply the resulting M×M matrix with (2/N)² to obtain F

Note that a and w are the same for steps 1 and 3.

Disk to Collector

The procedure for the disk-to-collector transform is the same as for the objective-to-disk transform if M and N are interchanged, and if the input mesh size is changed to 2u₀/M. If only the power distribution in the collector pupil is relevant steps (2) and (4) can be omitted (steps (2) and (3) can be interchanged). Because one N→M CZT requires two (N+M−1)-point FFT's, total number of (N+M−1)-point FFT's needed for a two-dimensional N×N-to-M×M transform is 2(N+M). Therefore, if L=N+M−1 we need (2L+2) L-point FFT's.

Resolution Considerations for the Invention

An advantageous property of the invention is that the size and resolution of the sampling grids may be chosen independently of each other. The objective/collector planes are sampled on a N×N grid, and the disk plane on a M×M grid, corresponding to a region with a user-defined (normalized) size 2u₀. There is no need for underfilling the objective plane as in Method I to obtain the required resolution in the disk plane. FIG. 4 shows the sampling grids for the embodiment. The dimensions are expressed in normalized units.

### EXAMPLE

With the same example as for Method I, we set the grid size equal to the collector's exit pupil diameter and choose N=84. To get a resolution of 44.3 nm in the disk plane we take M=429 (so that L=84+429−1=512) and choose 2ũ₀=429×44.3 nm=19.0 μm. The procedure according to the invention requires 1026 times a 512-point FFT. Just for Method I, 2048 times a 1024-point FFT is needed, and the number of multiplications for an N-point FFT is proportional to (N/2)log(N). Therefore, we expect for the invention an improvement in speed with a factor 2×2×(10/9)=4.4 with respect to Method I. In a straightforward Matlab implementation on the 1.7 GHz Pentium-4 PC the disk-to-collector transform did require 0.15 sec, which is about 5× faster than Method I. Moreover, the steps (3) and (4) of the scan procedure involve smaller matrices, i.e. 429×429 rather than 1024×1024, so that the number of complex computations in these steps for the embodiment is 5.7× less than for Method I.

Truncation Effects in the Invention

For the disk-to-collector transform the embodiment uses a subrange of the input range of it's associated DFT. For the same resolutions, this is identical to the DFT used in Method I. That is, the embodiment transforms—in terms of the discrete Fourier transform—a truncated sequence, while it also produces a truncated sequence. This implies that, in general, after two consecutive transforms the input sequence is not reproduced exactly.

A truncated sequence will yield ‘ringing’ in it's output after transformation (Gibb's effect), which may affect the numerical accuracy. An effective way to suppress such ringing is to apply a window in the input plane, which has the effect of gradually pushing the input samples towards zero near the truncation radius. It's important to note that Gibb's effect does not occur because vital information is missing in the truncated sequence. It occurs because Fourier components are truncated, which disrupts the balance between amplitudes and phases of the combined components. By removing the components above the truncation radius, the ones below this reading are ‘left behind’, and the large annihilating effects present between components in the untruncated sequence are disturbed, which introduces oscillations. For this reason a carefully designed window can almost or wholly remove the oscillations without affecting the overall response. If the truncation radius is chosen sufficiently larger than the radius of interest with respect to the required analysis, the window function will leave the system response unaffected.

As an illustration we consider the transform of an homogeneous circular pupil, which yields the well-known Airy pattern. When the pupil field is transformed and subsequently transformed back, an oscillatory output field results.

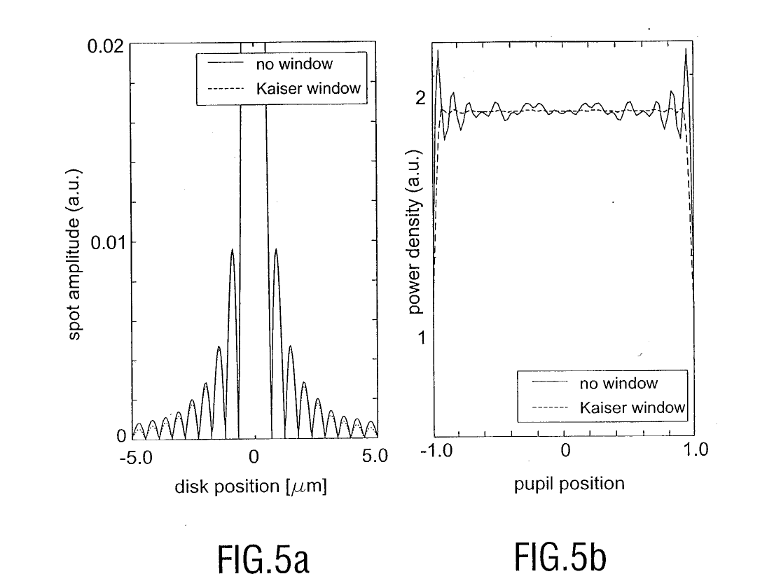

By applying a window on the transformed pupil the oscillations can be suppressed to a large extent while the final response is hardly affected, as is apparent from FIG. 5. FIG. 5a shows the computed magnitude of the output field after the first transform, using the parameters of the DVD example. It shows the Airy pattern (continuous line), truncated at a radius of ũ₀=9.5 μm. After a second transform the truncation results in severe ringing in the output plane, shown in the power density plot of FIG. 5b (continuous line). By applying a so-called Kaiser window⁴ with a shape parameter β=4, the sidelobes are attenuated towards the truncation radius (FIG. 5a, dashed line), which suppresses the oscillations in the final output field (FIG. 5b, dashed line).

The window effectively removes the ringing, at the expense of a slight decrease of overall response near the pupil edges. For the practical example above, the resulting loss of accuracy is negligible: the residual ringing in the power of the output field is less than 1% at a FWHM of 98% of the pupil diameter. The window attenuates the amplitude of e.g. the fourth ring of the Airy pattern by still only 10%. Since the read-out of a sequence of pits is fully dominated by the central lobe and the first few rings, the accuracy obtained is not compromised. In case of DVD, with an average pit length of 0.67 μm and a track pitch of 0.74 μm, pits located at a distance of 10 μm or more from the center of the spot don't contribute to the readout signal. This justifies the zoom-in approach of the chirp z-transform.

The window operation involves a term-by-term multiplication with a M×M matrix, but as this can be precomputed and incorporated in the spot amplitude, it does not add to the scan time.

Verification

Both methods have been implemented in software and their results compared for a variety of spot/disk configurations. In the disk plane we use a sample resolution of 44.3 nm and the pupils are sampled on a 84×84 grid. For Method I we use N=1024 and R=12.2, for the embodiment we use N=84, M=429, and a Kaiser window with β=4.

The parameters included in the disk model are the width, depth, slope and length of the pits, the thickness and refraction index of the plastic substrate and the pitch of the spiral track. The spot parameters include the wavelength, NA, objective lens pupil illumination profile (e.g. gaussian for a solid state laser system) and—if required—various wavefront aberrations.

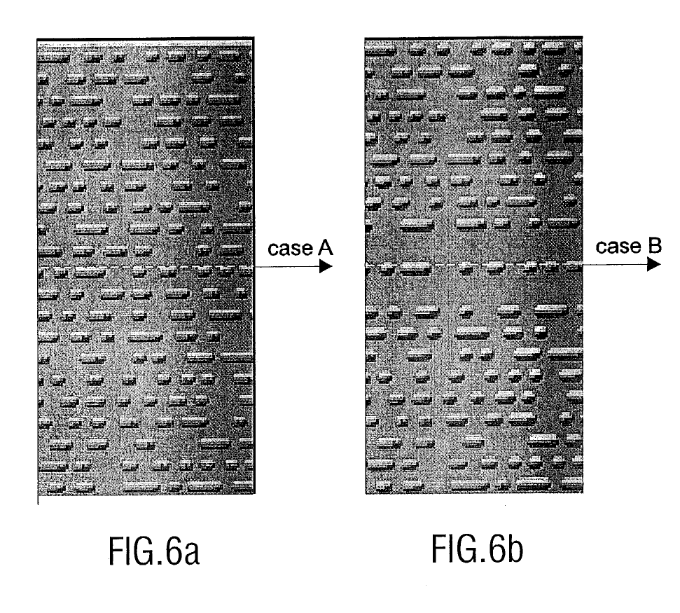

An example of a test configuration is shown in FIG. 6, for a typical disk geometry according the DVD standard for two cases.

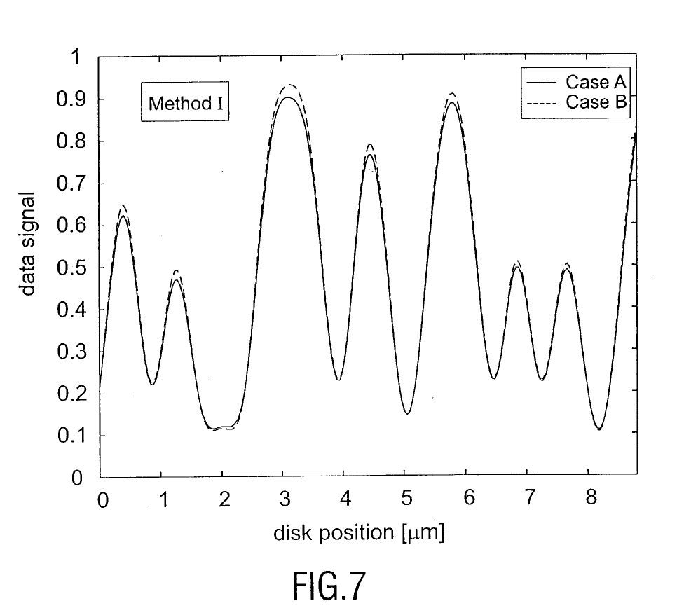

In order to compare the two methods, a target track is scanned twice over a certain distance. The first scan is done with all tracks present (FIG. 6a) and the second one with the tracks adjacent to the target track removed (FIG. 6b). The idea is that as the (radial) environment differs for the two cases, only a model that correctly incorporates crosstalk in both dimensions will produce the same results as our reference method. FIG. 7 shows the data signal obtained by Method I for these two cases.

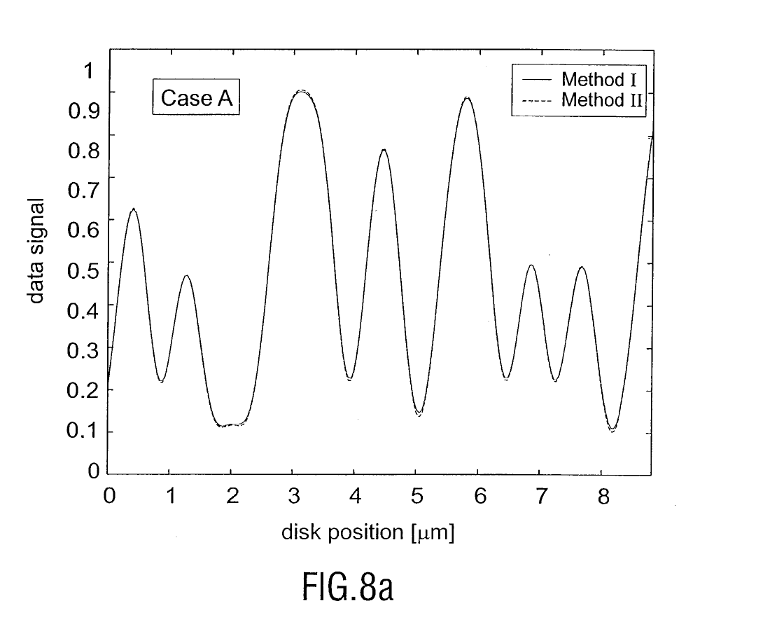

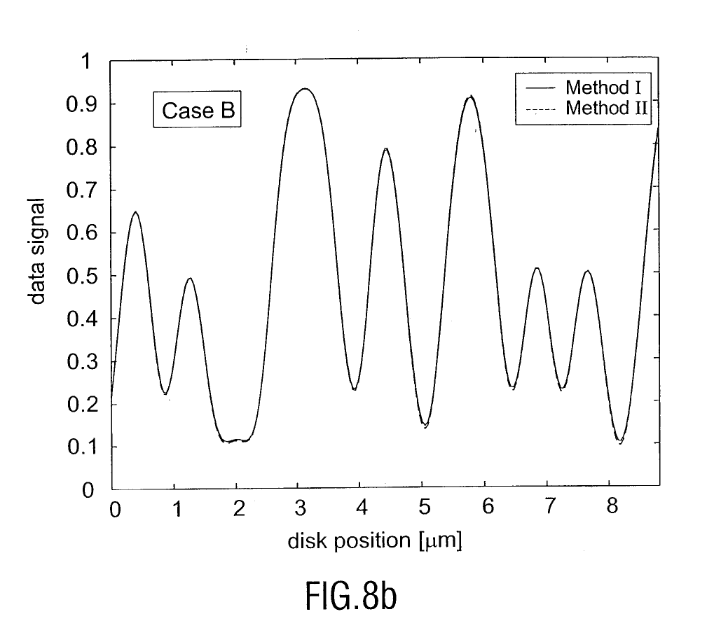

A difference is clearly present between both scans, but is not dramatic in magnitude. The same cases were simulated using the embodiment and the results compared with those of Method I, see FIGS. 8a and 8b.

An almost perfect match between both methods is found, and the embodiment seems indeed capable to handle the rather subtle change in environment. Other configurations were simulated, involving both lower- and higher density disks, highly aberrated spots, and several servo signals. In all cases a near perfect match between the two methods was found.

Finally it must be noted that the simple readout configuration of FIG. 1 is easily extended to a more complete configuration found in practical readers and writers. A very useful extension of the model is the addition of a full detector branch, involving e.g. a (de-)collimator lens, an astigmatic lens for invoking a focus error signal and a (quadrant-) detector positioned between the focal planes. The simulation model is then extended by adding a (third) Fourier transform, which can again be evaluated by applying the embodiment. This allows for an accurate analysis of the focus s-curve and the sensitivity of various signals for detector misalignment.

Conclusions

An efficient method for the computation of optical disk readout was presented. The method evaluates the Fourier transforms not directly by two-dimensional FFT's, but makes use of the so-called chirp z-transform which uses FFT's of a smaller size. This yields a considerable improvement in efficiency, and because the matrices involved in the additional processing are significantly smaller, also the other—i.e. non-transform—computations become more efficient.

For the simulation of a typical DVD system an overall improvement of a factor 5 was found, with virtually the same accuracy as the direct 2D-FFT approach.

1. A method for calculating an optical disk readout signal that represents a light power distribution, whilst executing the following simulated steps:
passing a beam of coherent light with wavelength λ through an entrance objective's pupil and focusing the beam on the disk for interaction
after interaction with the disk, collecting the light through an optical collector lens for passage through an exit pupil operating as a detection plane
and executing to calculate a light power distribution on said detection plane, for a range of potential disk positions R(u,v), and such including to calculate the following:
$$\begin{matrix}F ( {u}_{k} , {v}_{l} ) = 2 R \text{/} N {\sum }_{m = 0}^{N - 1} A ( {x}_{m} , {v}_{l} ) exp [ - 2 i {u}_{k} {x}_{m} ] , k = 0 … M - 1 , \\ with A ( {x}_{m} , {v}_{l} ) = 2 R \text{/} N {\sum }_{n = 0}^{N - 1} f ( {x}_{m} , {y}_{n} ) exp [ - 2 i {v}_{l} , {y}_{n} ] , l = 0 … M - 1 ,\end{matrix}$$
said method being characterised by using a chirp z-transform (CZT) which transforms a vector ƒ of length N to a vector A of length M according to
$${A}_{k} = {[ CZT ( f ) ]}_{k} = {\sum }_{n = 0}^{N - 1} {{f}_{n} ( {aw}^{- k} )}^{- n} , k = 0 …M - 1 ,$$
where a and w are user-defined complex constants to define a spiral path z=aw^{-k} in the z-plane.

2. A method as claimed in claim 1, wherein the objective and collector lenses have substantially identical numerical apertures.

3. A method as claimed in claim 1, whilst allowing for doing away with underfill as defined by the ratio of the sizes of sampling area and the pupil, respectively, that is, through using R≡1.

4. A method as claimed in claim 1, whilst choosing the various sampling grids independently of each other.

5. A method as claimed in claim 1, whilst applying an “anti-ringing” window in the input plane.

6. A method as claimed in claim 5, whilst choosing the window's truncation radius sufficiently larger than the radius of interest for thereby maintaining the system response.

7. A method as claimed in claim 5, wherein said window has a shape that is colloquially known as a Kaiser window.

8. A computer program comprising instructions for controlling a computer whilst implementing a method as claimed in claim 1.

9. A computer program product contained in a tangible read-only medium for co-operating with a computer facility in implementing a method as claimed in claim 1.

10. An apparatus being arranged for executing a method as claimed in claim 1, and comprising presentation means for presenting various operational parameters for the calculation, processing control means for controlling executing of said method, processing means for executing various processing steps under control of said processing control means and whilst being fed by said presentation means, and user output means for outputting user data regarding light power output data of a simulated light output signal.
